(19) United States
(12) Patent Application Publication
(10) Pub. No.: US 2012/0314334 A1
(43) Pub. Date: Dec. 13, 2012

(54) EHD DEVICE IN-SITU AIRFLOW

(75) Inventors: Nels Jewell-Larsen, San Jose, CA (US); Kenneth A. Honer, Santa Clara, CA (US)

(73) Assignee: TESSERA, INC., San Jose, CA (US)

(21) Appl. No.: 13/485,559

(22) Filed: May 31, 2012

Related U.S. Application Data
(60) Provisional application No. 61/494,793, filed on Jun. 8, 2011.

(51) Int. Cl. H01T 23/00

(52) U.S. Cl. 361/231

(57) ABSTRACT

An electrohydrodynamic (EHD) air mover is positionable within the enclosure to, when energized, motivate air flow through the enclosure along a flow path between the inlet and outlet ventilation boundaries. Ductwork within the enclosure has cross-sections substantially matched to a cross-section of the EHD air mover. A fan curve-type, pressure-air flow characteristic measured for the EHD air mover in open air substantially overstates mechanical impedance of the EHD air mover to air flow along the flow path between the inlet and outlet ventilation boundaries in that, when the EHD air mover is operably positioned within the enclosure appurtenant to the ductwork, no more than about 50% of the mechanical impedance of the EHD air mover indicated by the measured fan curve-type, pressure-air flow characteristic actually contributes to total mechanical impedance to air flow through the enclosure along the flow path between the inlet and outlet ventilation boundaries.

### CROSS REFERENCE TO RELATED APPLICATIONS

The present application claims the benefit of U.S. Provisional Application No. 61/494,793, filed Jun. 8, 2011, which is incorporated herein in its entirety by reference.

### BACKGROUND

The present application relates to fluid movers and, more particularly, to micro-scale cooling devices that generate ions and electrical fields to motivate flow of fluids, such as air, as part of a thermal management solution to dissipate heat.

Devices built to exploit ionic movement of a fluid are variously referred to in the literature as ionic wind machines, electric wind machines, corona wind pumps, electro-fluid-dynamic (EFD) devices, electrohydrodynamic (EHD) thrusters, EHD gas pumps and EHD fluid or air movers. Some aspects of the technology have also been exploited in devices referred to as electrostatic air cleaners or electrostatic precipitators.

When employed as part of a thermal management solution, an ion flow fluid mover may result in improved cooling efficiency with reduced vibrations, power consumption, electronic device temperatures and/or noise generation. These attributes may reduce overall lifetime costs, device size or volume, and in some cases may improve system performance or user experience.

As electronic device designers drive to smaller and smaller form-factors, such as in the extremely thin consumer electronics devices popularized by iPhone™, iPad™ and iMac™ devices available from Apple, Inc., packing densities of components and subsystems create significant thermal management challenges. In some cases, active strategies to exhaust heat to the ambient environment may be required. In some cases, mass transport across a ventilation boundary may be unnecessary, but heat transport within the device may be necessary or desirable to reduce hotspots.

Ion flow fluid movers present an attractive technology component of thermal management solutions. Solutions are desired that allow ion flow fluid movers to be integrated in thin and/or densely packed electronic devices, often in volumes that provide as little as 5-8 mm of clearance in a critical dimension.

### SUMMARY

It has been discovered that, given form factors of interest for thin, low-profile or high-aspect-ratio electronics devices, EHD fluid mover designs may be accommodated in positions and/or forms that are generally impractical for conventional, mechanical fan or blower designs. Specifically, EHD fluid mover designs with grossly disproportionate heights and widths may fit within the extremely limited dimensions available within a device enclosure. In some cases, channel heights of 3-5 mm or less, but with channel widths of 50-75 mm, may be accommodated. At these high-aspect ratios, it has been discovered that the mechanical resistance to flow of EHD fluid mover designs described herein is dominated by inlet and outlet losses rather than by losses in the EHD fluid mover channel. However, inlet and outlet loss dominated open-air measurements of flow impedance (such as measured fan curve-type, pressure-air flow characteristics) may be misdescriptive of performance achievable in properly matched systems.

Instead, properly matched in-system ducting can provide solutions in which less than 50% of the measured open-air, flow impedance of an EHD air mover may actually contribute to actual, in situ, mechanical impedance to air flow through the system. Indeed, in some high-aspect rectangular channel EHD air mover configurations described herein, 30%, 20% or less of an otherwise measured open-air, flow impedance of the EHD air mover may actually impede flow through the system. This discovery is significant for a wide range of commercial exploitations in which measured open-air, flow impedance is an important figure of merit typically considered in ventilation/thermal management system design and evaluation.

As demonstrated herein, an EHD air mover can be designed, in conjunction with matched ductwork, to act like an ideal pressure source with only a small additional system impedance. More specifically, building on the designs and experimental results described herein, system configurations have been developed in which only nominal pressure drops (e.g., about 1 Pa at 1.0 cfm of flow or about 2 Pa at 1.5 cfm of flow) occur through the EHD air mover.

In some embodiments in accordance with the present invention(s), an electronic device an enclosure having inlet and outlet ventilation boundaries and an electrohydrodynamic (EHD) air mover positioned within the enclosure to, when energized, motivate air flow through the enclosure along a flow path between the inlet and outlet ventilation boundaries. The EHD air mover has leading and trailing flow path cross-sections with major and minor dimensions, the minor dimensions each less than about 8 mm and the major dimensions each at least ten times (10×) the respective minor dimension. Greater than 50% of a measurable open air, mechanical impedance to air flow of the EHD air mover is attributable to inlet and exhaust losses at the respective leading and trailing flow path cross-sections. Leading and trailing flow path cross-sections of the EHD air mover are substantially matched to complementary cross-sections of the flow path within the enclosure, such that less than 50% of the measurable open air mechanical impedance contributes to total mechanical impedance to air flow through the enclosure along the flow path between the inlet and outlet ventilation boundaries.

In some cases, the EHD air mover contributes no more than about 20% of the total mechanical impedance to air flow through the enclosure along the flow path between the inlet and outlet ventilation boundaries. In some cases, the EHD air mover, when introduced into the electronic device, contributes no more than about 6 Pa of pressure drop to a total pressure drop along the flow path between the inlet and outlet ventilation boundaries.

In some cases, flow motivating elements of the EHD air mover consist essentially of (i) an emitter electrode and (ii) a pair of collector electrode surfaces, the emitter electrode spanning at least a substantial portion of the major dimension of the leading flow path cross-section, and the collector electrode surfaces mounted along major dimension sidewalls of the flow path through the EHD air mover generally parallel to longitudinal extent of the emitter electrode. In some cases, leading and trailing flow path cross-sections of the EHD air mover are essentially rectangular. In some cases, leading and trailing flow path cross-sections of the EHD air mover are essentially identical.

In some embodiments, the electronic device further includes a heat source disposed within the enclosure; and heat transfer surfaces thermally coupled to the heat source and introduced into the air flow through the enclosure.

In some cases, the minor dimensions are less than about 5 mm, and the major dimensions are each at least twenty times (20×) the respective minor dimension. In some cases, greater than 75% of the measurable open air, mechanical impedance to air flow of the EHD air mover is attributable to inlet and exhaust losses at the respective leading and trailing flow path cross-sections. Leading and trailing flow path cross-sections of the EHD air mover are substantially matched to complementary cross-sections of the flow path within the enclosure, such that less than 25% of the measurable open air mechanical impedance contributes to total mechanical impedance to air flow through the enclosure along the flow path between the inlet and outlet ventilation boundaries.

In some embodiments in accordance with the present invention(s), an electronic device includes an enclosure having inlet and outlet ventilation boundaries; an electrohydrodynamic (EHD) air mover positionable within the enclosure to, when energized, motivate air flow through the enclosure along a flow path between the inlet and outlet ventilation boundaries; and ductwork within the enclosure having cross-sections substantially matched to a cross-section of the EHD air mover. A fan curve-type, pressure-air flow characteristic measured for the EHD air mover in open air substantially overstates mechanical impedance of the EHD air mover to air flow along the flow path between the inlet and outlet ventilation boundaries in that, when the EHD air mover is operably positioned within the enclosure appurtenant to the ductwork, no more than about 50% of the mechanical impedance of the EHD air mover indicated by the measured fan curve-type, pressure-air flow characteristic actually contributes to total mechanical impedance to air flow through the enclosure along the flow path between the inlet and outlet ventilation boundaries.

In some cases, no more than about 25% of the mechanical impedance of the EHD air mover indicated by the measured fan curve-type, pressure-air flow characteristic actually contributes to the total mechanical impedance to air flow through the enclosure along the flow path between the inlet and outlet ventilation boundaries. In some cases, the measured fan curve-type, pressure-air flow characteristic has no more than about 30 Pa of static pressure and less than 3 cfm of flow.

In some cases, the actually contributed mechanical impedance of the EHD air mover results in a pressure drop through the EHD air mover of no more than about 1 Pa at 1.0 cfm of flow. In some cases, the actually contributed mechanical impedance of the EHD air mover results in a pressure drop through the EHD air mover of no more than about 2 Pa at 1.5 cfm of flow.

These and other embodiments will be understood with reference to the description herein, the drawings and the appended claims.

### BRIEF DESCRIPTION OF THE DRAWINGS

The present invention may be better understood, and its numerous objects, features, and advantages made apparent to those skilled in the art by referencing the accompanying drawings. Drawings are not necessarily to scale; rather, emphasis has instead been placed upon illustrating the structural and fabrication principles of the described embodiments.

FIG. 1A is a perspective view of an illustrative, pad-type, consumer electronics device in which, in accord with some embodiments of the present invention, an EHD fluid mover is accommodated within a total device thickness of typically less than about 10 mm, including the thickness of a display surface that covers a substantial entirety of a major surface thereof. FIG. 1B depicts (in general correspondence with an interior volume of the device of FIG. 1A) an illustrative ventilating air flow topology and placement of an EHD fluid mover relative to respective electronic assemblies. FIG. 1C illustrates another illustrative ventilating air flow topology and placement of an EHD fluid mover relative to respective electronic assemblies.

FIG. 2A is a perspective view of an illustrative, pad-type, consumer electronics device, again in accord with some embodiments of the present invention, in which an EHD fluid mover is accommodated within a total device thickness of typically less than about 10 mm, including the thickness of a display surface that covers a substantial entirety of a major surface thereof. FIG. 2B depicts (in general correspondence with an interior volume of the device of FIG. 2A) an illustrative recirculating fluid flow topology and placement of an EHD fluid mover relative to respective electronic assemblies. FIG. 2C illustrates a variation in which the flow topology includes both a circulating flow component and some flow that enters and exits the device through ventilation boundaries.

FIGS. 3, 5 and 6 depict, in illustrative cross-sections, device configurations in which electrostatically operative portions of an EHD fluid mover are formed as, or on, respective surfaces of a device enclosure and/or Electromagnetic Interference (EMI) shield overlaying an electronic assembly. FIGS. 5 and 6 depict illustrative cross-sections in which a display surface is part of the device stack that includes an EHD fluid mover.

FIG. 4 depicts an illustrative high voltage power supply configuration in which emitter and collector electrodes are energized to motivate fluid flow.

FIG. 7A is a perspective view of an illustrative, laptop-style, consumer electronics device in which, in accord with some embodiments of the present invention, an EHD fluid mover is accommodated within a total device thickness of typically less than about 10 mm. FIGS. 7B and 7C depict (in respective plan views and generally in correspondence with a base portion the laptop-style device of FIG. 7A) illustrative positional relations between components and ventilating air flows. FIG. 7C depicts an interior view with illustrative positioning an EHD air mover, whereas FIG. 7B depicts a top surface view in which the keyboard (and its underlying electronic assembly) at least partially overlays the EHD air mover.

FIGS. 8A and 8C depict, in illustrative cross-sections, an device configuration that includes an EHD air mover. In some realizations, FIG. 8A corresponds generally to a cross-section shown in FIGS. 7B and 7C. FIG. 8B depicts a partial interior view of an electrostatically operative, air-flow-permeable surface of the EHD air mover illustrated in FIG. 8A. FIG. 8C depicts a cross-section wherein an exoskeletal structure of an EHD air mover subassembly facilitates relative positional fixation of collector and emitter electrodes with respect to each other, and wherein at least a portion of one of the electrostatically operative surfaces is formed over a portion of the exoskeletal structure.

FIGS. 9A and 9B depict, in further illustrative cross-sections, device configurations that includes an EHD air mover. In some realizations, FIGS. 9A and 9B correspond to variations in which a circuit board-type electronic assembly is part of the device stack that includes the EHD fluid mover.

FIGS. 10A and 10B are respective edge-on side and perspective views of an illustrative, flat panel display style, consumer electronics device in which, in accord with some embodiments of the present invention, an EHD fluid mover is accommodated within a total device depth typically less than about 10 mm.

FIG. 11A is an interior view (generally in correspondence with flat panel display device of FIGS. 10A and 10B) illustrating positional relations between components and ventilating air flows. FIGS. 11B and 11C depict, in illustrative cross-sections of the flat panel display device, portions of respective EHD air movers.

FIG. 12 is a fan curve prediction.

FIG. 13 is a fan curve inferred from first-principles.

FIG. 14 is a comparison with experimental fan curve.

FIG. 15 is an electrohydrodynamic (EHD) performance wind tunnel fixture.

FIG. 16 illustrates duct length causes little additional pressure loss.

FIG. 17 illustrates measured airflow substantially higher than predicted.

FIG. 18 illustrates using open-air fan curves double counts inlet and outlet effects, which are significant for SAC blowers.

FIG. 19 summarizes observations.

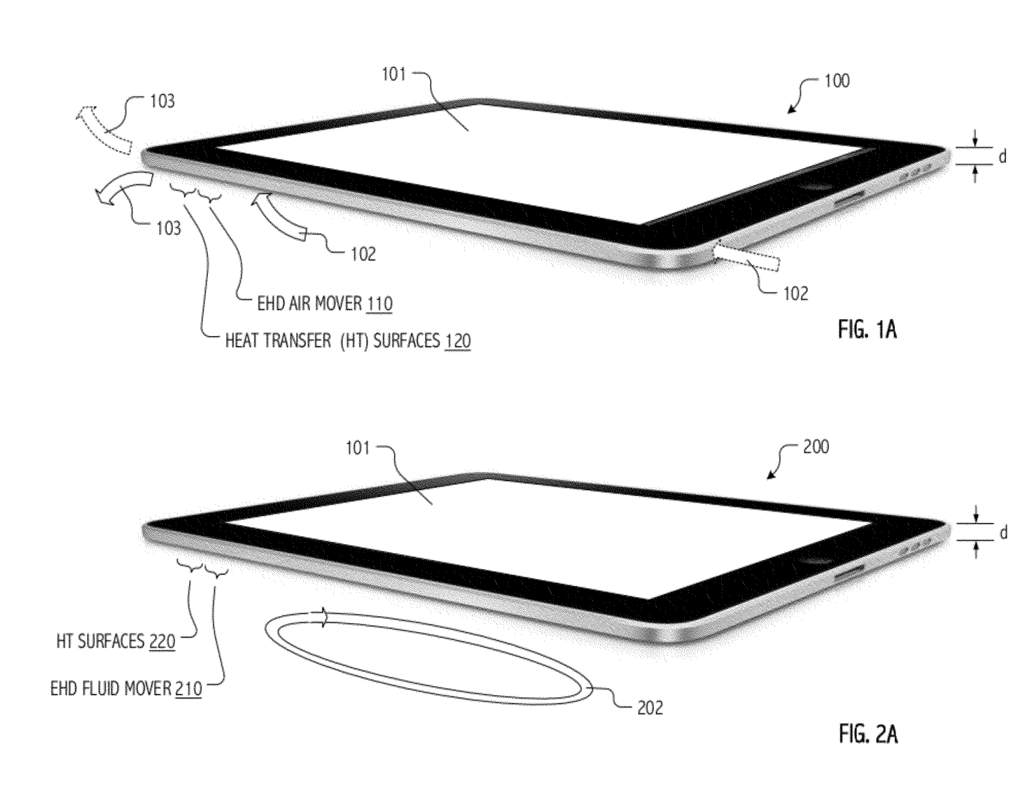

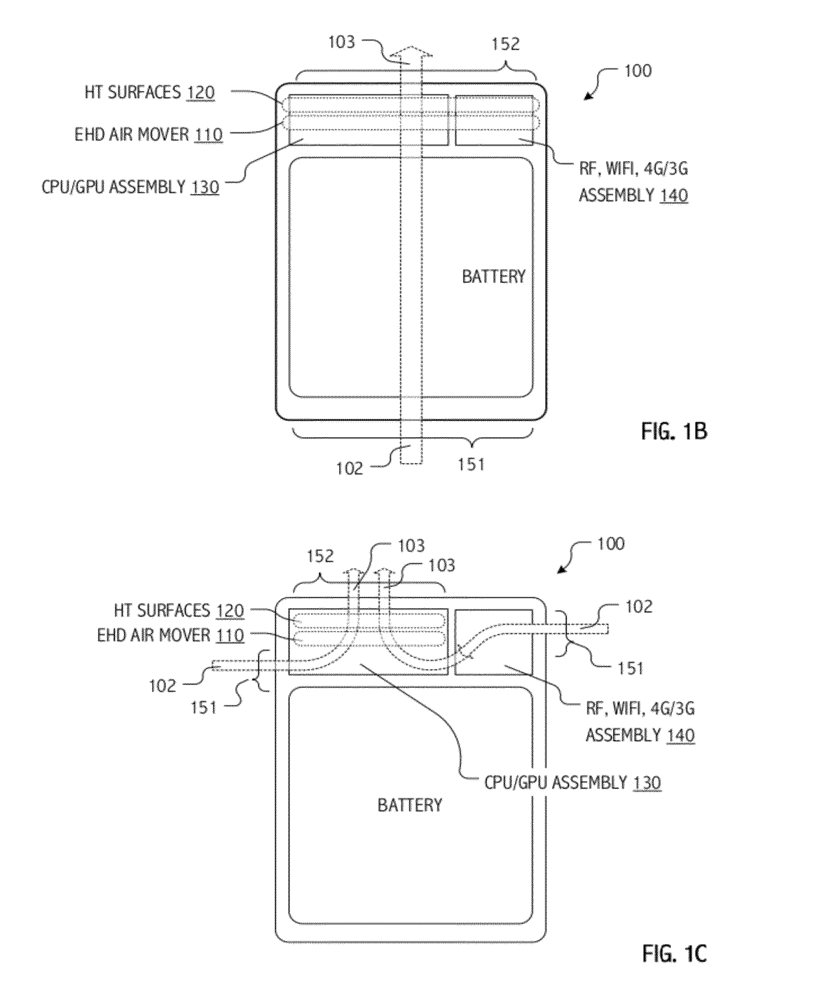

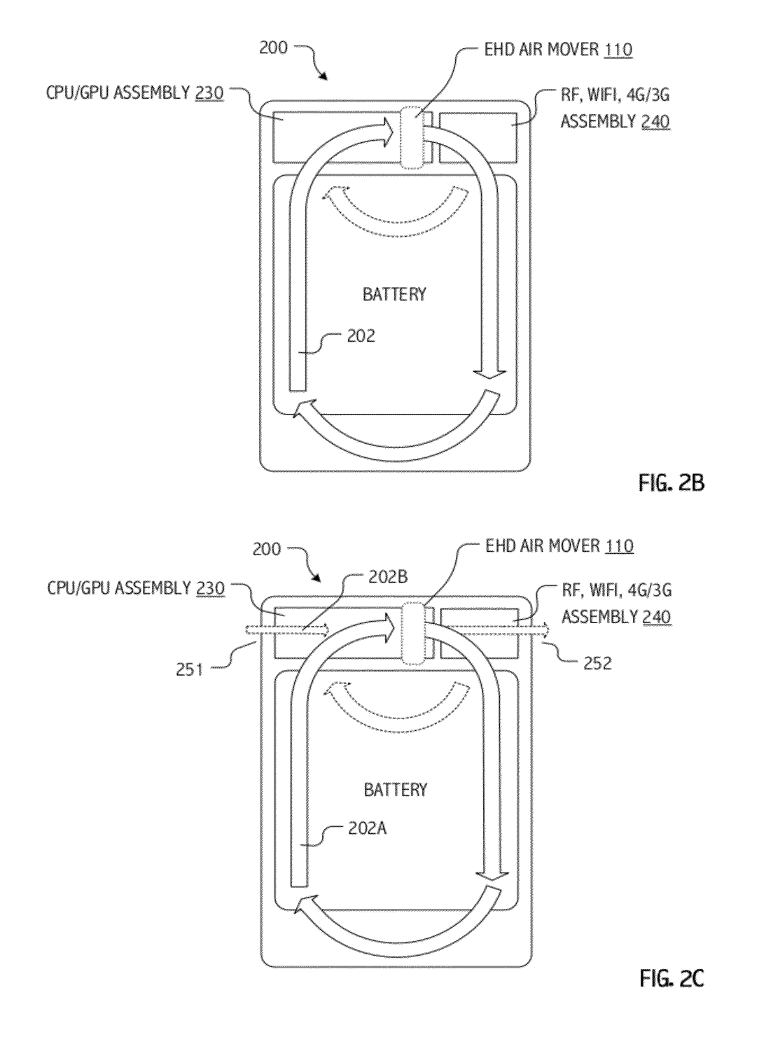

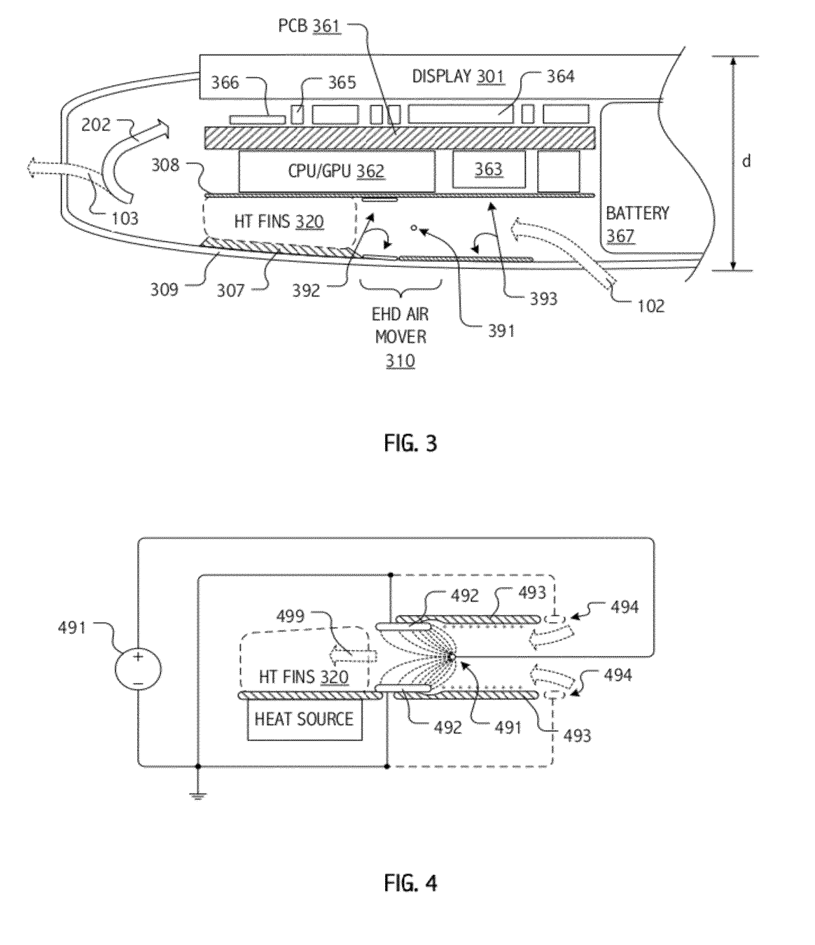

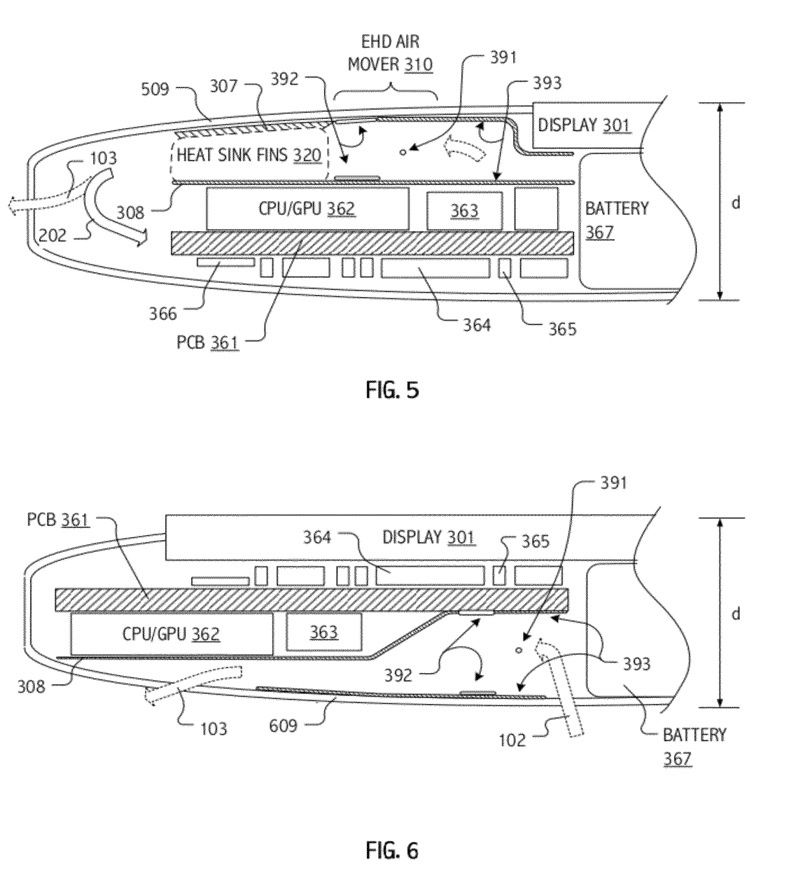

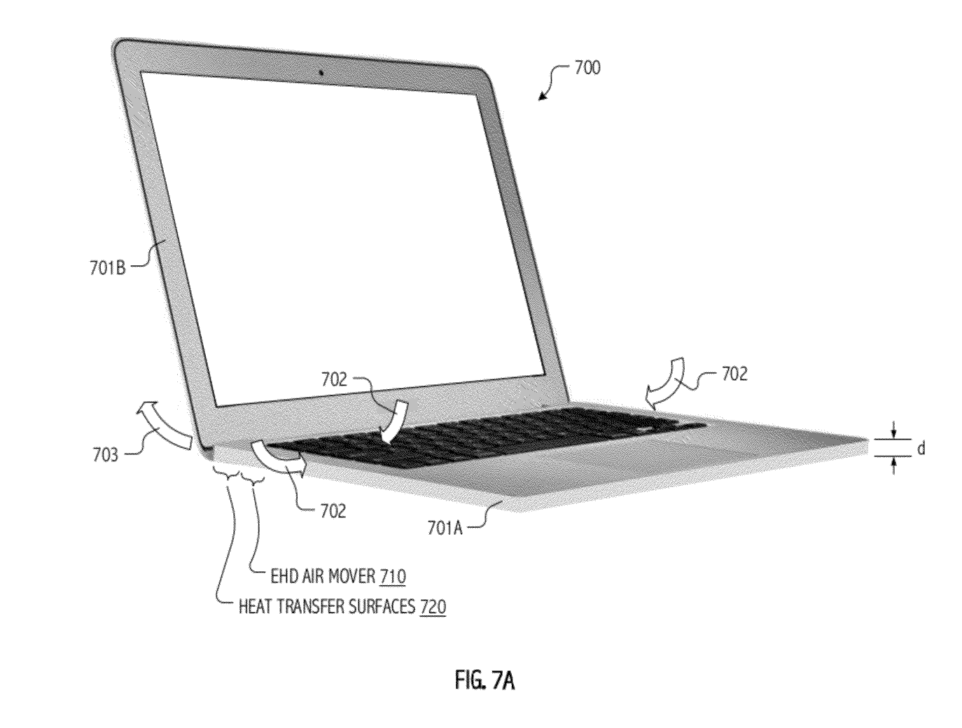

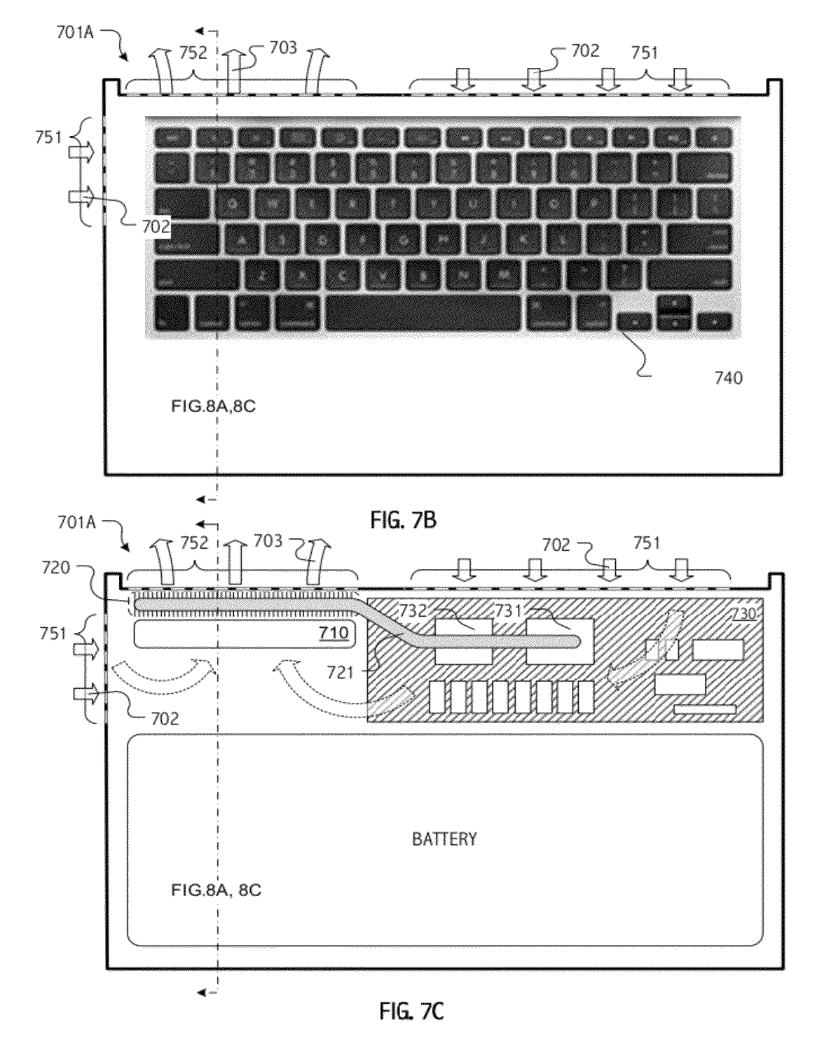

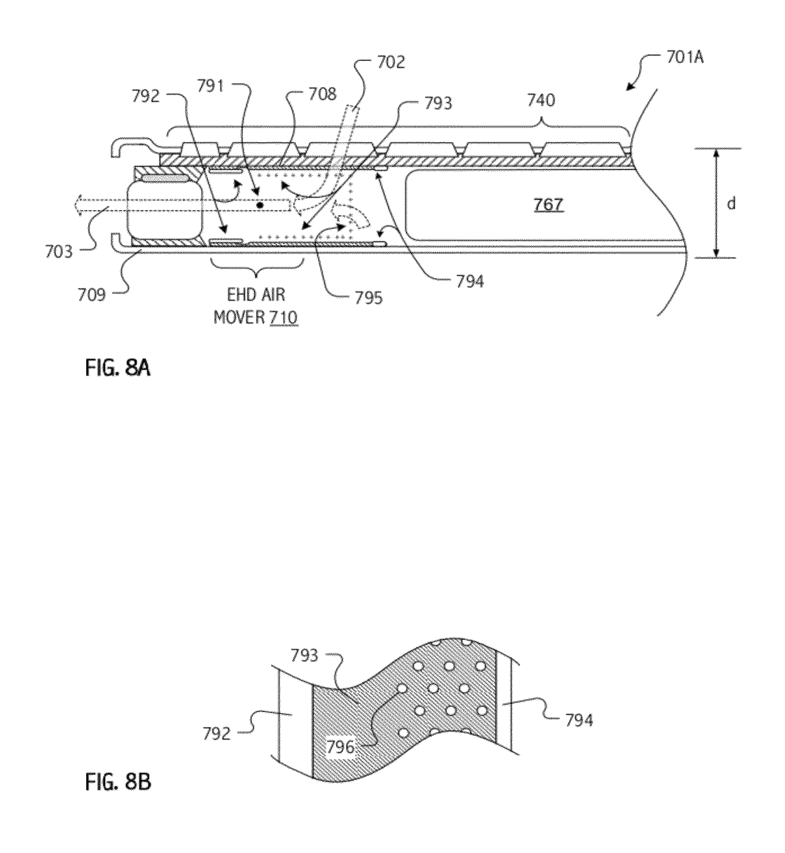

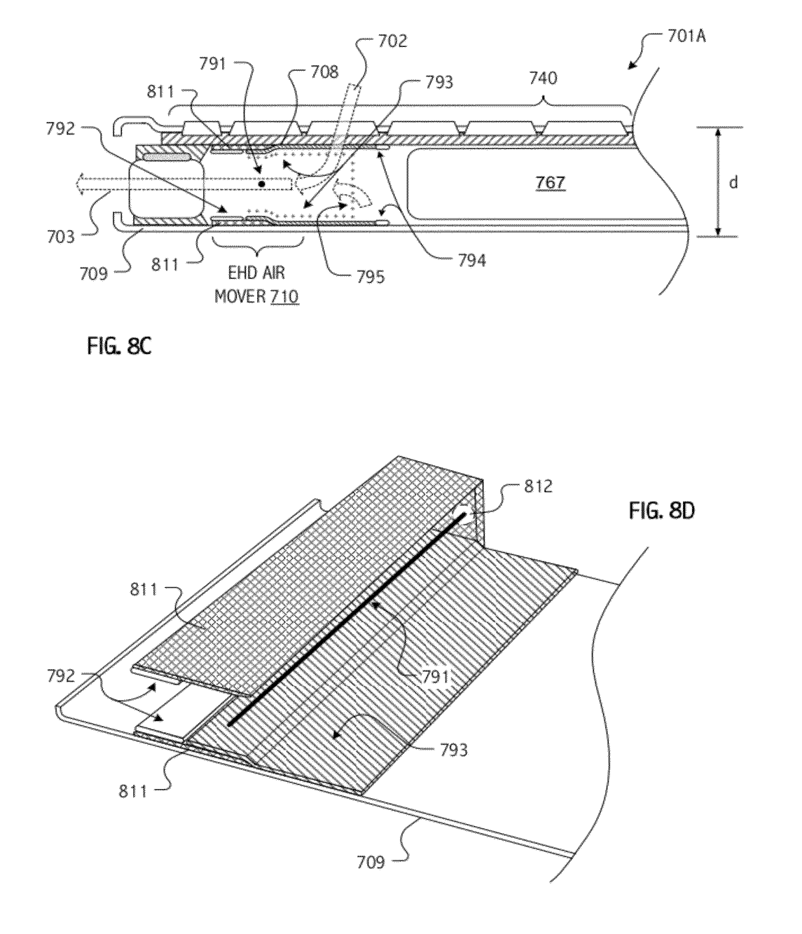

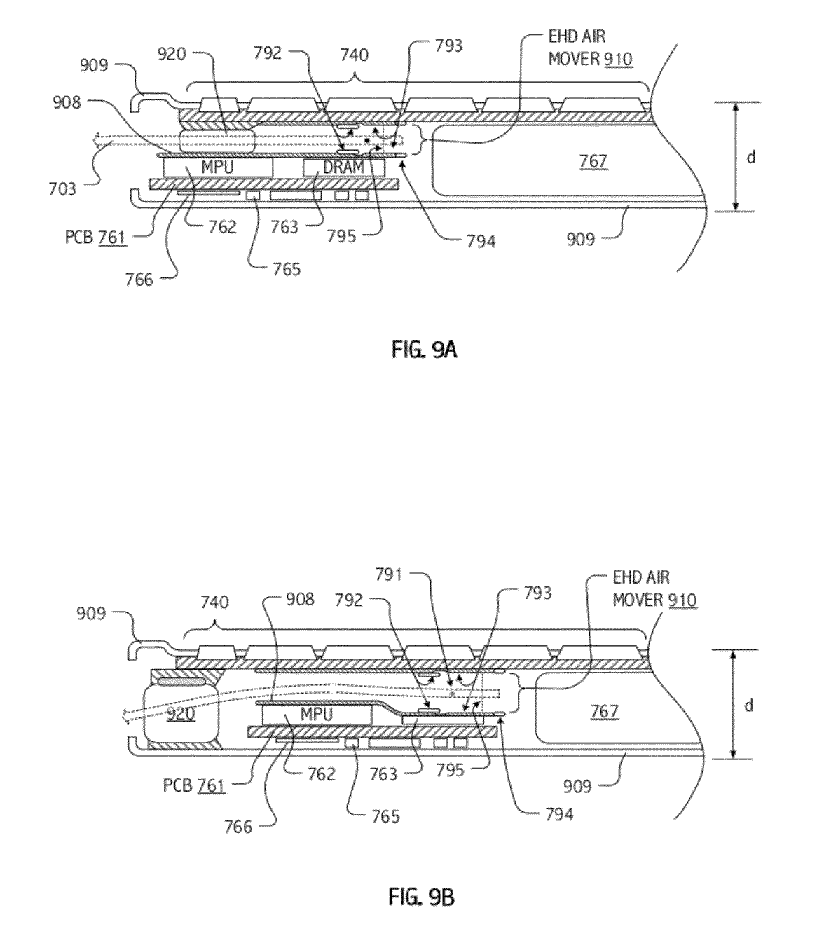

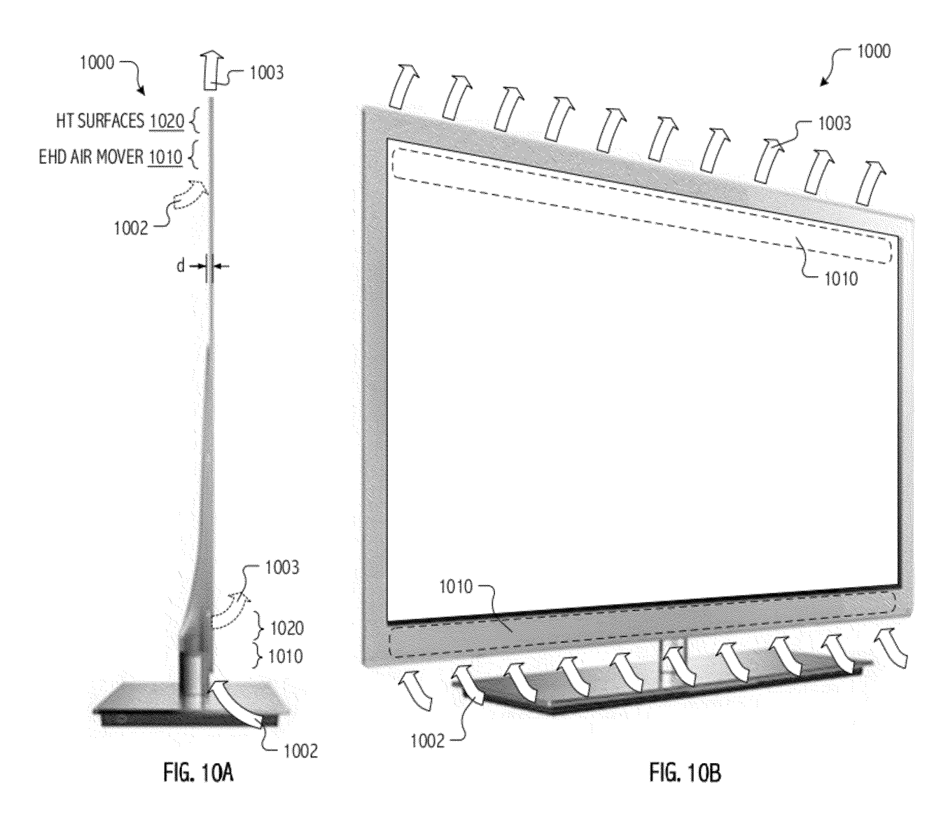

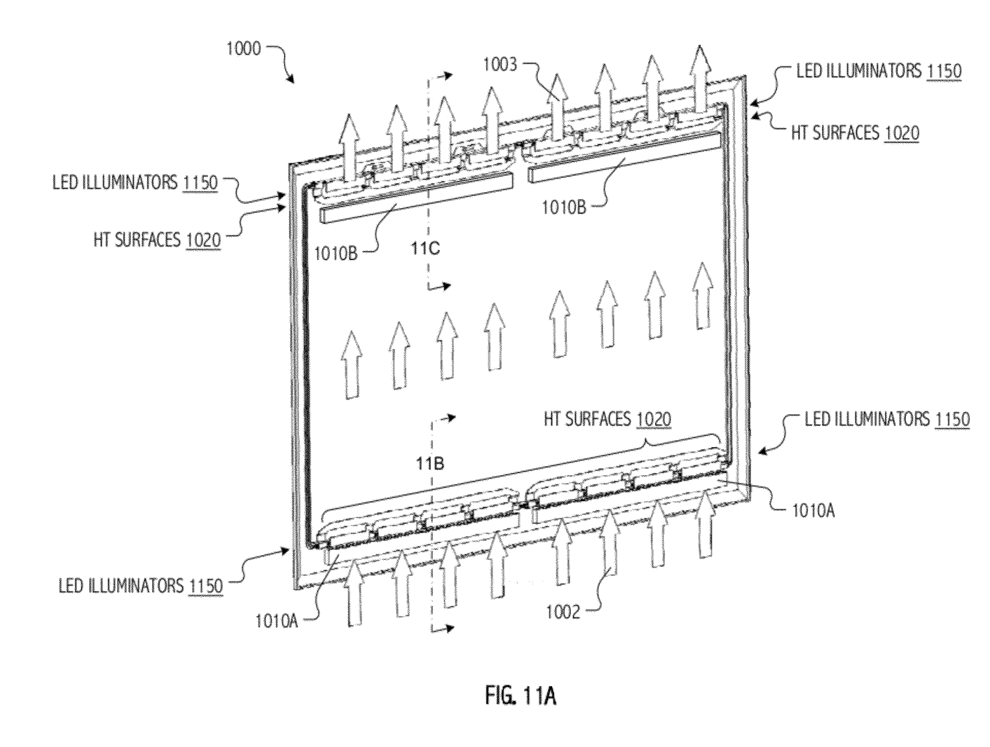

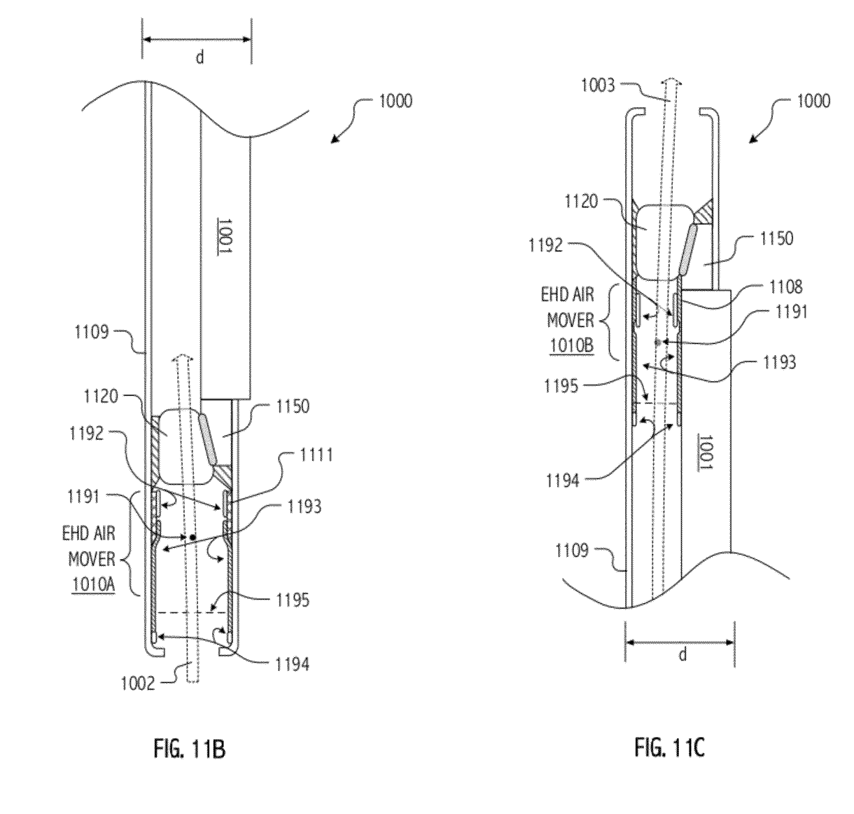

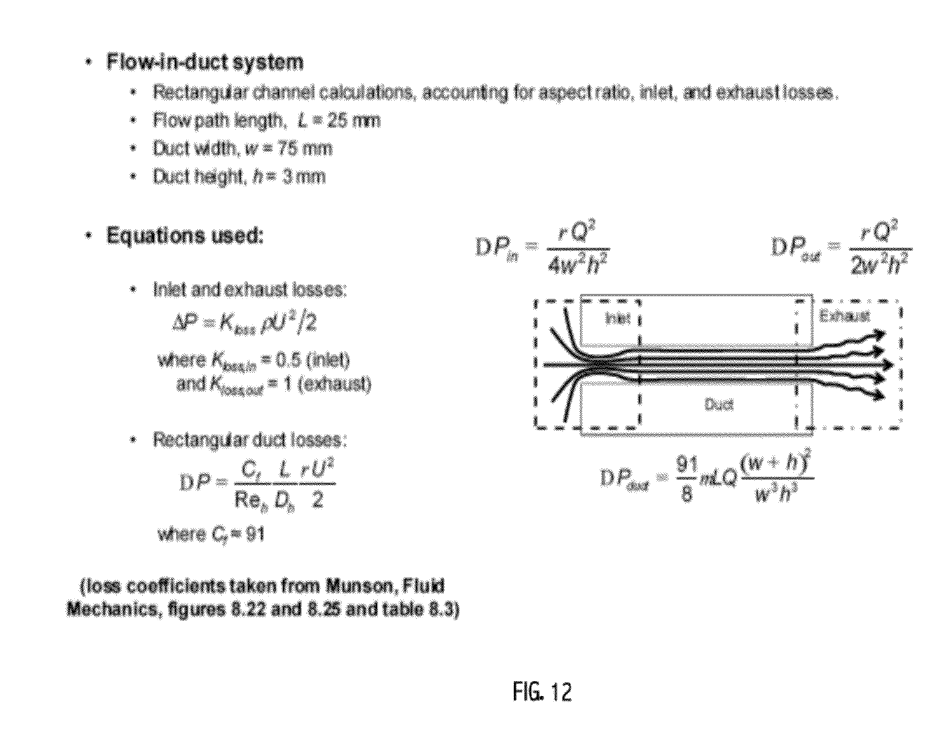

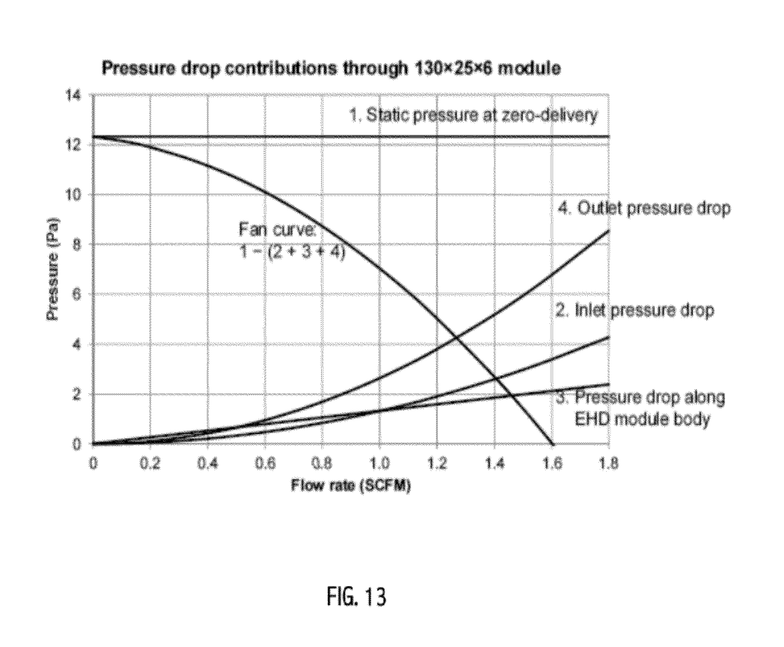

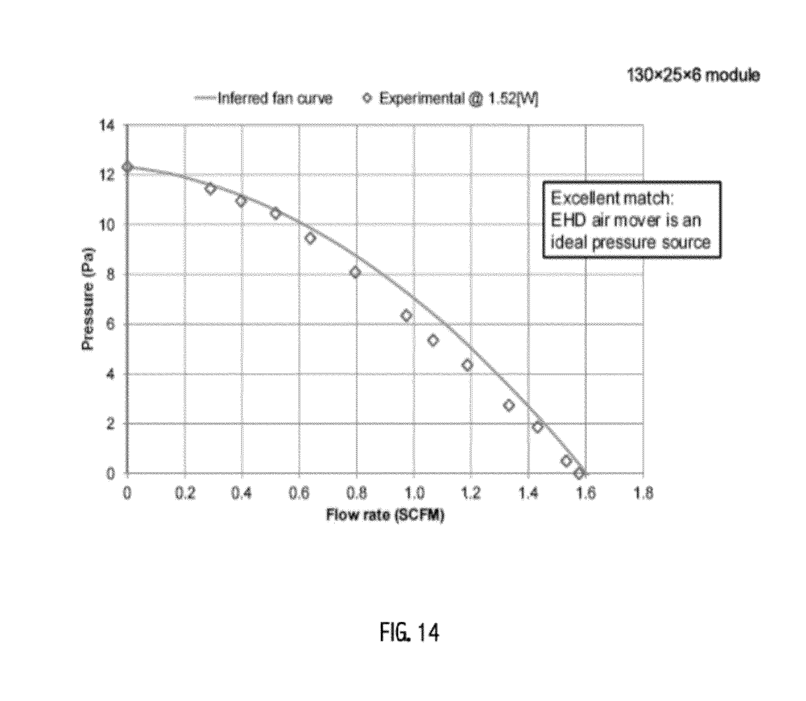

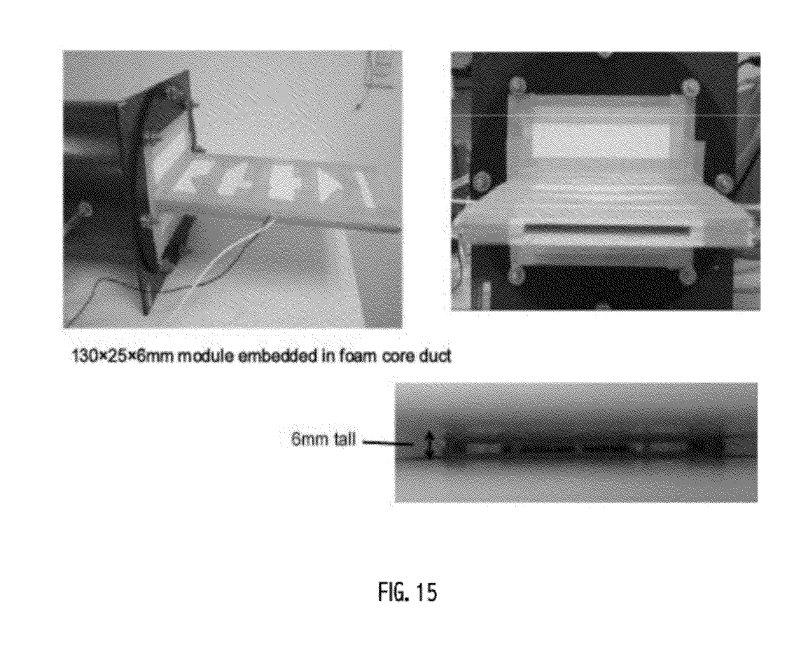

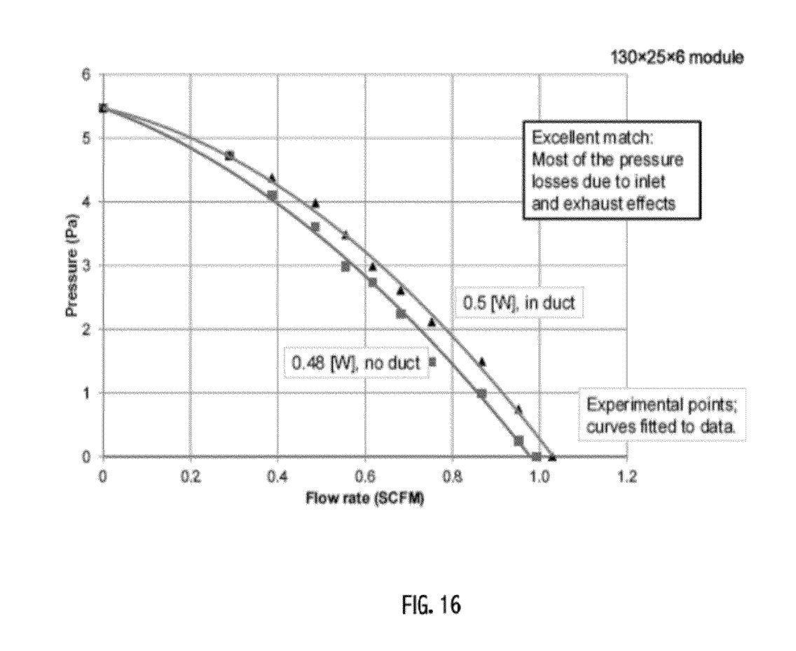

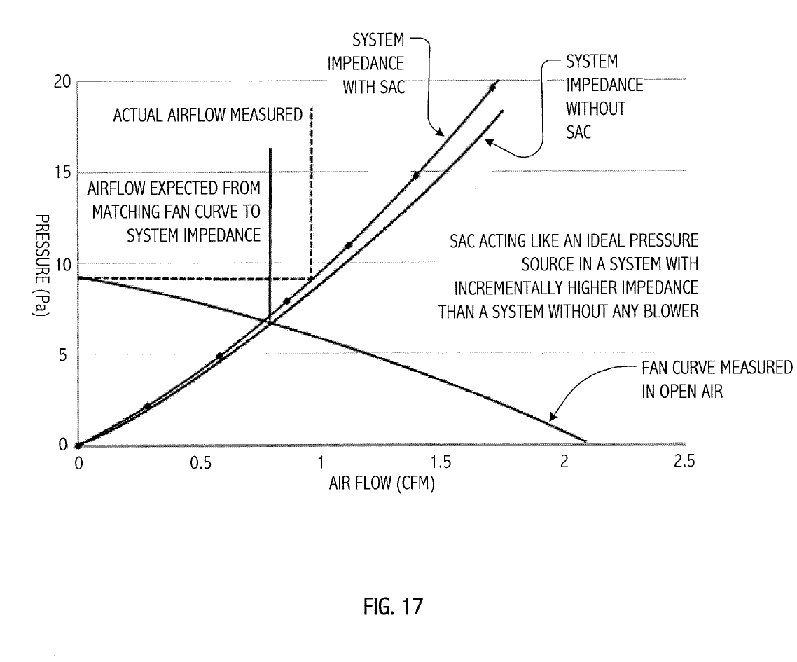

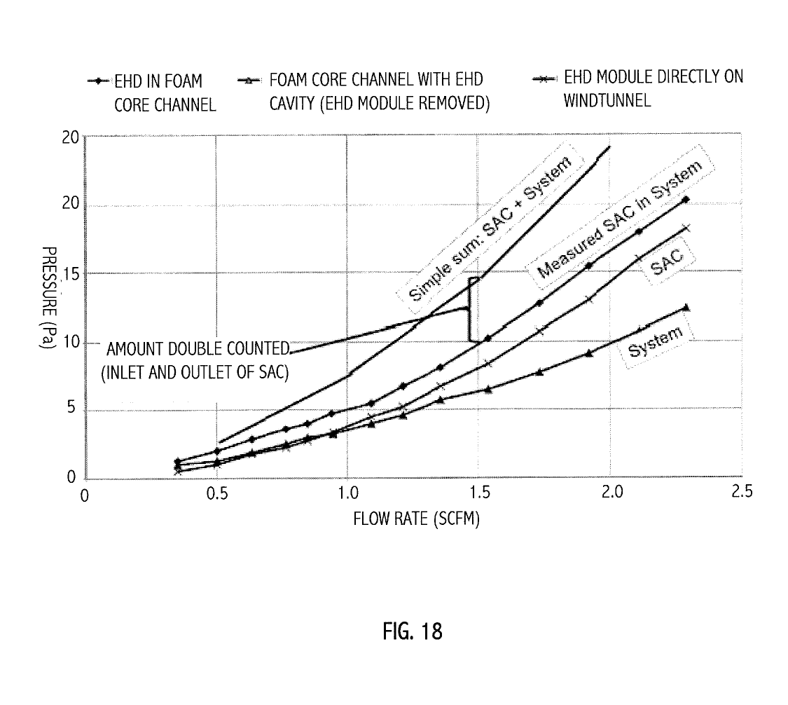

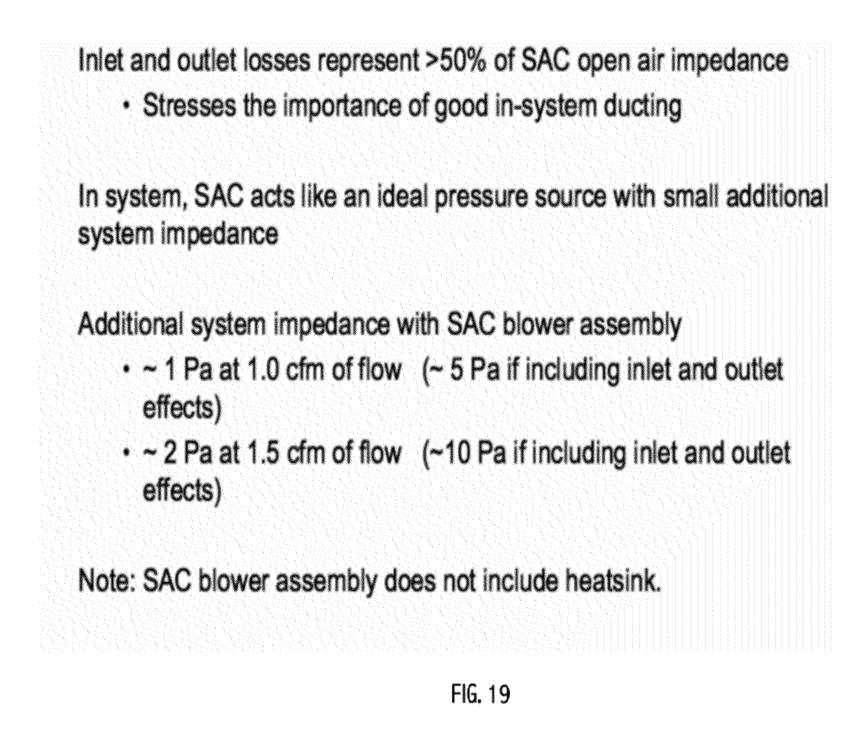

Use of the same reference symbols in different drawings indicates similar or identical items.

### DETAILED DESCRIPTION

As will be appreciated, many of the designs and techniques described herein have particular applicability to the thermal management challenges of densely-packed devices and small form-factors typical of modern consumer electronics. Indeed, some of the EHD fluid/air mover designs and techniques described herein facilitate active thermal management in electronics whose thinness or industrial design precludes or limits the viability of mechanical air movers such as fans, blowers, etc. In some embodiments, such EHD fluid/air movers may be fully integrated in an operational system such as a pad-type or laptop computer, a projector or video display device, a set-top box, etc. In other embodiments, such EHD fluid/air movers may take the form of subassemblies or enclosures adapted for use in providing such systems with EHD motivated flows.

In general, a variety of scales, geometries and other design variations are envisioned for electrostatically operative surfaces that provide field shaping or that functionally constitute a collector electrode, together with a variety of positional interrelationships between such electrostatically operative surfaces and the emitter and/or collector electrodes of a given EHD device. For purposes of illustration, certain exemplary embodiments and certain surface profiles and positional interrelationships with other components are illustrated in the drawings, which are described in detail in commonly-owned, co-pending U.S. patent application Ser. No. 13/105,343, entitled “ELECTROHYDRODYNAMIC FLUID MOVER TECHNIQUES FOR THIN, LOW-PROFILE OR HIGH-ASPECT-RATIO ELECTRONIC DEVICE” and naming Jewell-Larsen, Honer, Goldman and Schwiebert as inventors, the entirety of which is incorporated by reference.

In the interest of compactness of disclosure, description from the above-incorporated '343 application is not duplicated herein. Rather, illustrative drawings from the '343 application are included and will be understood by persons of ordinary skill in the art based on (i) description of the above-incorporated '343 application and (ii) the analysis, description and illustrations of the attached presentation slides that follow.

While the techniques and implementations of the EHD devices discussed herein have been described with reference to exemplary embodiments, it will be understood by those skilled in the art that various changes may be made and equivalents may be substituted for elements thereof without departing from the scope of the appended claims. In addition, many modifications may be made to adapt a particular situation or material to the teachings without departing from the essential scope thereof. Therefore, the particular embodiments, implementations and techniques disclosed herein, some of which indicate the best mode contemplated for carrying out these embodiments, implementations and techniques, are not intended to limit the scope of the appended claims.

What is claimed is:

1. An electronic device comprising:
an enclosure including inlet and outlet ventilation boundaries;
an electrohydrodynamic (EHD) air mover positioned within the enclosure to, when energized, motivate air flow through the enclosure along a flow path between the inlet and outlet ventilation boundaries,
the EHD air mover having leading and trailing flow path cross-sections with major and minor dimensions, the minor dimensions each less than about 8 mm and the major dimensions each at least ten times (10×) the respective minor dimension,
wherein greater than 50% of a measurable open air, mechanical impedance to air flow of the EHD air mover is attributable to inlet and exhaust losses at the respective leading and trailing flow path cross-sections, and
wherein the leading and trailing flow path cross-sections of the EHD air mover are substantially matched to complementary cross-sections of the flow path within the enclosure, such that less than 50% of the measurable open air mechanical impedance contributes to total mechanical impedance to air flow through the enclosure along the flow path between the inlet and outlet ventilation boundaries.

2. The electronic device of claim 1,
wherein the EHD air mover contributes no more than about 20% of the total mechanical impedance to air flow through the enclosure along the flow path between the inlet and outlet ventilation boundaries.

3. The electronic device of claim 1,
wherein the EHD air mover, when introduced into the electronic device, contributes no more than about 6 Pa of pressure drop to a total pressure drop along the flow path between the inlet and outlet ventilation boundaries.

4. The electronic device of claim 1,
wherein flow motivating elements of the EHD air mover consist essentially of (i) an emitter electrode and (ii) a pair of collector electrode surfaces, the emitter electrode spanning at least a substantial portion of the major dimension of the leading flow path cross-section, and the collector electrode surfaces mounted along major dimension sidewalls of the flow path through the EHD air mover generally parallel to longitudinal extent of the emitter electrode.

5. The electronic device of claim 1,
wherein leading and trailing flow path cross-sections of the EHD air mover are essentially rectangular.

6. The electronic device of claim 1,
wherein leading and trailing flow path cross-sections of the EHD air mover are essentially identical.

7. The electronic device of claim 1, further comprising:
a heat source disposed within the enclosure; and
heat transfer surfaces thermally coupled to the heat source and introduced into the air flow through the enclosure.

8. The electronic device of claim 1,
wherein the minor dimensions are less than about 5 mm, and
wherein the major dimensions are each at least twenty times (20×) the respective minor dimension.

9. The electronic device of claim 1,
wherein greater than 75% of the measurable open air, mechanical impedance to air flow of the EHD air mover is attributable to inlet and exhaust losses at the respective leading and trailing flow path cross-sections, and
wherein the leading and trailing flow path cross-sections of the EHD air mover are substantially matched to complementary cross-sections of the flow path within the enclosure, such that less than 25% of the measurable open air mechanical impedance contributes to total mechanical impedance to air flow through the enclosure along the flow path between the inlet and outlet ventilation boundaries.

10. An electronic device comprising:
an enclosure including inlet and outlet ventilation boundaries;
an electrohydrodynamic (EHD) air mover positionable within the enclosure to, when energized, motivate air flow through the enclosure along a flow path between the inlet and outlet ventilation boundaries; and
ductwork within the enclosure having cross-sections substantially matched to a cross-section of the EHD air mover,
wherein a fan curve-type, pressure-air flow characteristic measured for the EHD air mover in open air substantially overstates mechanical impedance of the EHD air mover to air flow along the flow path between the inlet and outlet ventilation boundaries in that, when the EHD air mover is operably positioned within the enclosure appurtenant to the ductwork, no more than about 50% of the mechanical impedance of the EHD air mover indicated by the measured fan curve-type, pressure-air flow characteristic actually contributes to total mechanical impedance to air flow through the enclosure along the flow path between the inlet and outlet ventilation boundaries.

11. The electronic device of claim 10,
wherein no more than about 25% of the mechanical impedance of the EHD air mover indicated by the measured fan curve-type, pressure-air flow characteristic actually contributes to the total mechanical impedance to air flow through the enclosure along the flow path between the inlet and outlet ventilation boundaries.

12. The electronic device of claim 10,
wherein the measured fan curve-type, pressure-air flow characteristic has no more than about 30 Pa of static pressure and less than 3 cfm of flow.

13. The electronic device of claim 10,
wherein the actually contributed mechanical impedance of the EHD air mover results in a pressure drop through the EHD air mover of no more than about 1 Pa at 1.0 cfm of flow.

14. The electronic device of claim 10,
wherein the actually contributed mechanical impedance of the EHD air mover results in a pressure drop through the EHD air mover of no more than about 2 Pa at 1.5 cfm of flow.
